(19) United States
(12) Patent Application Publication
(10) Pub. No.: US 2023/0381689 A1
(43) Pub. Date: Nov. 30, 2023

(54) PHASE SEPARATOR WITH INTERLEAVED BAFFLES

(71) Applicant: Sand Separation Technologies Inc., Acheson (CA)

(72) Inventors: Chris Michael Johnston, St. Albert (CA); Ryan Shawn Van Drecht, Yarmouth (CA); Dakota Anthony Bieleski, Grande Prairie (CA); Ahmed Tashmid, Grande Prairie (CA)

(21) Appl. No.: 18/248,360

(22) PCT Filed: Oct. 8, 2021
(86) PCT No.: PCT/CA2021/051427

§ 371 Date: Apr. 7, 2023

Related U.S. Application Data
(60) Provisional application No. 63/090,032, filed on Oct. 9, 2020.

(51) Int. Cl. B01D 21/00; B01D 21/24

(52) U.S. Cl. CPC B01D 21/0042; B01D 21/2405; B01D 21/2494

(57) ABSTRACT

A particulate separator having a top baffle extends radially from an outer edge toward a vertical axis. The top baffle is positioned between an inlet port and a fluid outlet port. A radial flow channel extends below the top baffle from the outer edge toward the fluid outlet port. A series of baffles are positioned concentrically about the fluid outlet port and within the radial flow channel. The series of baffles include a first set of baffles having a top edge connected to a bottom surface of the top baffle and a bottom edge spaced below the top edge. A second set of baffles have a top edge spaced from a bottom surface of the top baffle. The first set of baffles are interleaved with the second set of baffles to define an alternating flow path along the radial flow channel from the outer edge to the fluid outlet port.

### TECHNICAL FIELD

This relates to a phase separator, and in particular, a phase separator for separating particulates from a fluid stream.

### BACKGROUND

In hydrocarbon production operations, fluid flows may include multiple phases, which may include oil, water, particulates, and entrained or dissolved gas. The particulates are solids and may be referred to in the industry as “sand”, even though they may or may not include silicates. It is often useful to separate one or more of these phases. In one example, particulates may be separated from a multiphase flow made up of liquid hydrocarbons, with varying amounts of water and/or gas phases. One example of a separator used to separate sand from a liquid flow may be found in U.S. Pat. No. 8,623,221 (Boyd et al.) entitled “Sand separator for petroleum and natural gas wells”.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of a particulate separator.

FIG. 2 is a top plan view in section of the phase separator of FIG. 1.

FIG. 3 is a bottom plan view in section of the phase separator of FIG. 1.

FIG. 4 is a perspective view of the series baffles within the separator vessel of FIG. 1.

FIG. 5 is a side elevation view in section of a phase separator with gas vents.

FIG. 6 is a partially-cutaway perspective view of the phase separator shown in FIG.

FIG. 7 is a partially-transparent top plan view of the separator shown in FIG. 5.

FIG. 8 is a side elevation view of a phase separator without a bottom baffle.

FIG. 9 is a side elevation view of a phase separator with a perforated bottom baffle.

FIG. 10 is a side elevation view in section of a phase separator with a perforated baffle above the bottom baffle.

FIG. 11 is a side elevation view of a phase separator with a series of angled baffles.

FIG. 12 is a side elevation view in section of a phase separator with vanes above the top baffle.

FIG. 13 is a side elevation view in section of a vertically-oriented phase separator.

FIG. 14 is a side elevation view in section of a horizontally-oriented phase separator.

### DETAILED DESCRIPTION OF PREFERRED EMBODIMENTS

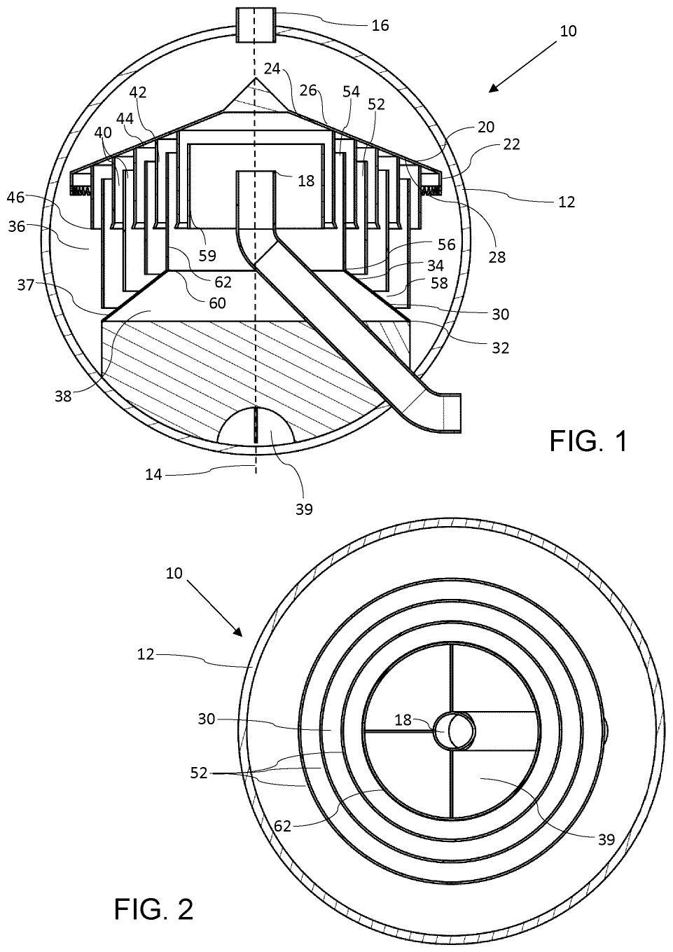

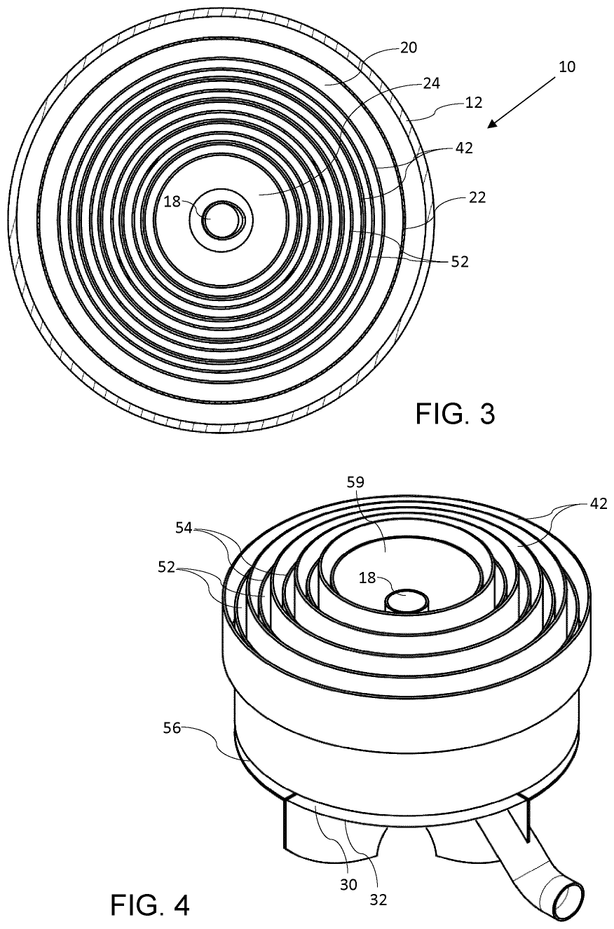

A phase separator, generally identified by reference numeral 10, will now be described with reference to FIG. 1 through 14.

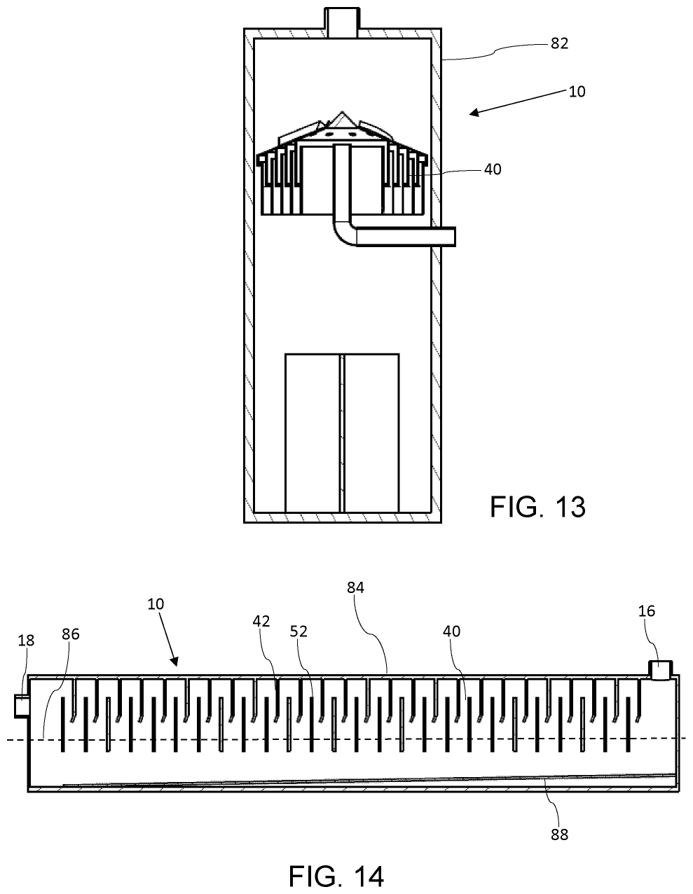

Referring to FIG. 1 through FIG. 4, particulate separator has a vessel 12, such as a spherical vessel as shown with a vertical axis 14, an inlet port 16 toward a top of vessel 12, and a fluid outlet port 18. In the depicted example, inlet port 16 and outlet port 18 are aligned along vertical axis 14, although other positions may also be used. As vessel 12 is intended for use in high pressure applications, it is symmetrical and axis 14 is a true axis. However, in other designs, axis 14 may merely be a line that passes through vessel 12 that is intended to be vertically oriented when vessel 12 is installed. Other vessel shapes may also be possible, such as a vertical vessel 82 as shown in FIG. 13 or a horizontal vessel 84 as shown in FIG. 14. Vertical and horizontal vessels 82 and 84 may be cylindrical, which allows for greater structural integrity under high pressure.

Referring again to FIG. 1, within vessel 12 are a top baffle 20 and a bottom baffle 30. Top baffle 20 has an outer edge 22, a central portion 24 toward axis 14 relative to outer edge 22, a top surface 26 and a bottom surface 28. Bottom baffle 30 has an outer edge 32 and a central portion 34 toward axis 14 relative to outer edge 32, and a top surface 37. Bottom baffle 30 may have a bottom surface 38, which may define a sand-collection area 39. Each baffle 20 and 30 extend radially from outer edge 22 and 32 toward the vertical axis 14. Top baffle 20 is positioned between inlet port 16 and outlet port 18 such that fluid entering vessel 12 travels around top baffle 20 to reach outlet port 18. Bottom baffle 30 surrounds outlet port 18 such that top baffle 20 and bottom baffle 30 define a radial flow channel 36 from outer edges 22 and 32 toward fluid outlet port 18. As shown, both top baffle and bottom baffle 30 extend radially as well as vertically to define an inclined flow channel 36 toward outlet port 18. As shown, top baffle 20 and bottom baffle 30 have truncated cone shapes and define a slope upwards from outer edges 22 and 32 as they approach axis 14. Other shapes may also be possible, such as a stepped surface, a curved surface, etc. Alternatively, one or both of baffles 20 and 30 may be primarily horizontal baffles or may be angled at different angles toward outlet port 18.

A series of baffles 40 are positioned concentrically about fluid outlet port 18 and within flow channel 36 to create a flow path that alternates directions. Series of baffles 40 include a first set of baffles 42 and a second set of baffles 52. Baffles in the first set of baffles 42 have a top edge 44 connected to a bottom surface 28 of top baffle 20 and a bottom edge 46 spaced above top surface 37 of bottom baffle 30. Baffles in the second set of baffles 52 have a top edge 54 spaced from bottom surface 28 of top baffle 20. As shown, second set of baffles 52 may have bottom edges 56 spaced above bottom baffle 30 such that a flow gap 58 is defined between series of baffles 40 and bottom baffle 30. This allows particulates separated from the flow fluid to descend through vessel 12 toward sand-collection area 39. Particulates may be allowed to collect at the bottom of vessel 12 and may be removed during a servicing operation, or a sand cleanout port (not shown) may be provided that allows periodic or continuous removal of sand from vessel 12.

As shown, first set of baffles 42 are interleaved with second set of baffles 52 to define a flow path that alternates directions, such as a serpentine flow path along the flow channel 36 from the outer edge to the fluid outlet port. In this manner, a fluid flow that carries particulates and entering inlet port 16 will be required to flow toward the outer sidewall of vessel and then back toward outlet port 18 by passing through flow channel 36 and change direction as a result of series of baffles 40. The number and size of baffles 42 and 52 will depend on the preferences of the user and the intended application. As shown, fluid outlet 18 is positioned at an intermediate position relative to an innermost baffle 59, i.e. between the bottom edge and the top edge, to encourage as much change in direction as possible. In addition, bottom edge 56 of second set of baffles 52 may be angled away from vertical axis 14 to further encourage changes in flow direction.

In one example, bottom baffle 30 may include an inner edge 60 that defines a central opening to allow particulates that separate from the fluid flow to collect at the bottom of vessel 12. In this embodiment, second set of baffles 52 has an intermediate baffle 62 that is mounted to bottom baffle 30 at or near inner edge 60 of bottom baffle 30. This provides a shorter flow path for separated particulates, and reduces the likelihood they will be re-entrained as the fluid approaches fluid outlet port 18. Inner edge 60 may also define a path for water to flow upward from the bottom of vessel 12, as discussed below.

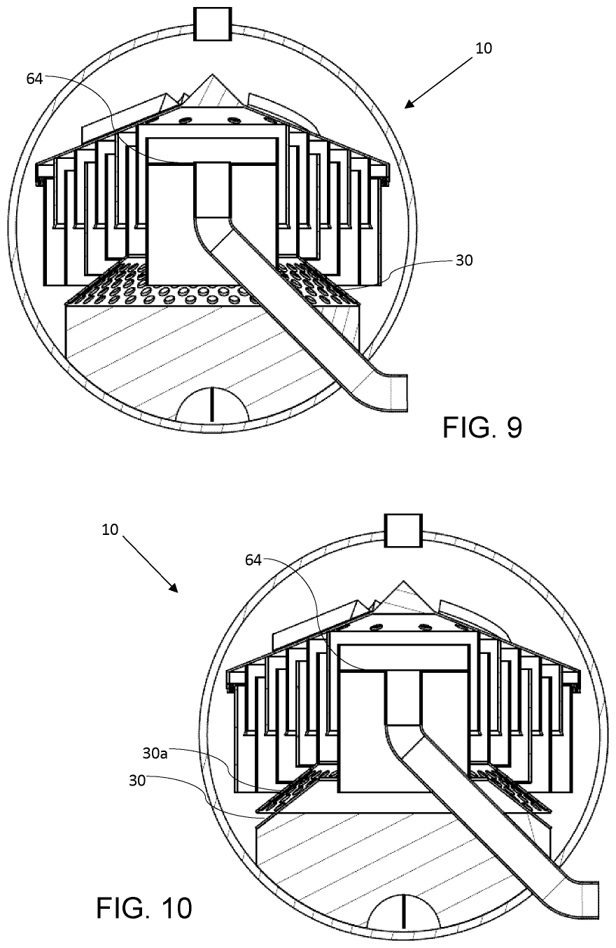

In another example, referring to FIG. 8-10, there may be a central baffle 64 that surrounds outlet port 18 to reduce turbulence within separator 10 around outlet port 18. This may be provided whether bottom baffle 30 is present, as in FIGS. 9 and 10, or not, as in FIG. 8.

Separator 10 as described above may be useful for separating particulates from many types of fluid flow, and may be used to remove sand trapped inside of thick and/or waxy oils. The example shown in FIG. 1 is a spherical vessel with a series of concentric ring-shaped baffles 40 that sit underneath top baffle 20, which is in the form of a dome, and hang down into the region of the flow channel 36. Baffles 40 alternate between first set of baffles 42, which are attached to the underside of the dome 20, and second set of baffles 52 which are not. This creates a serpentine path for the oil or emulsion layer to travel through the vessel towards fluid outlet port 18 toward the center of vessel 12. This creates a series of vertical channel sections within flow channel 36, or ‘shake-out traps’ where the oil rapidly changes in direction from moving downwards to moving upwards at the bottom of each vertical channel section. This creates a shearing force in the oil, which causes it to become thinner, as many oil emulsions act as shear-thinning fluids. The combination of the change in flow direction and shear thinning creates a region where particulates that are trapped in the oil can fall out of suspension and collect at the bottom of vessel 12.

Separator 10 may be designed and operated to encourage liquid hydrocarbons and not water through the series of baffles 40, which may be referred to as “shake-out traps”. The interleaved baffles 42 and 52 are arrayed such that oil and liquid hydrocarbons must pass through the ring system, and thus be subjected to the shearing action, to reach outlet port 18. Water, being heavier, may fall below the level of baffles 40 and will reach outlet port 18 by circulating up the center of vessel 12. The oil may be prevented from building up lower in vessel 12, and thus following the same path as the water, because of the difference in hydrostatic pressure from the column of water that builds up in the center of the vessel. In other words, the force from the inner water column may equalize with the force of the incoming oil flow, causing oil to flow through series of baffles 40, and water to flow up through the center of vessel 12 within inner edge 60 of bottom baffle 30.

Other variations are also possible, depending on the intended use and anticipated phases in the fluid flow.

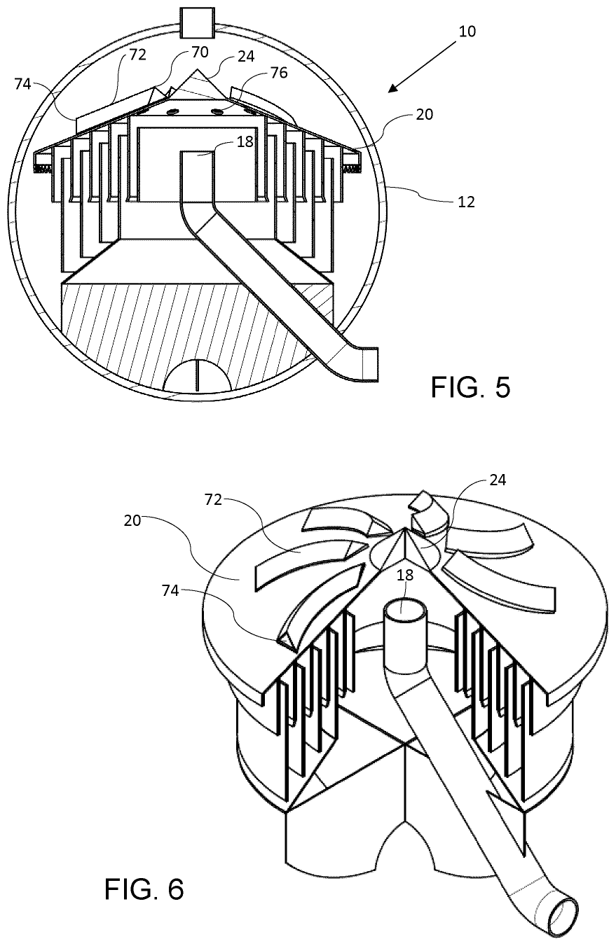

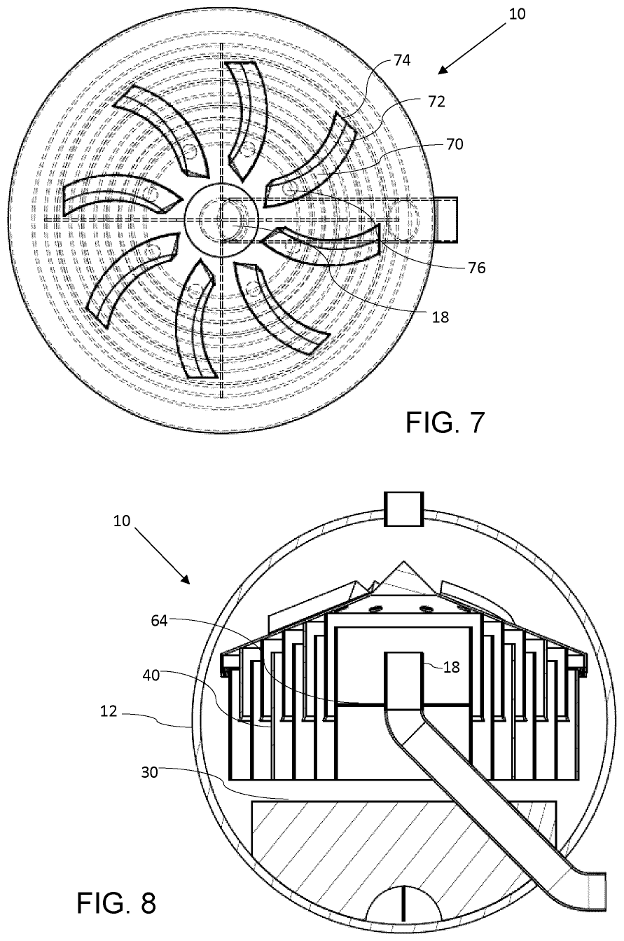

Referring to FIGS. 5 and 6, in cases where there is a significant gas or vapour content in the fluid flow, it may be useful to allow gas to flow through top baffle 20 by providing gas vents 70 in top baffle 20, such as at or near central portion 24 as shown. Referring to FIG. 7, the depicted gas vents 70 include channels 72 with openings 74 at an outer end of passages 72 that are in fluid communication with ports 76. In this way, gas is able to flow through top baffle to outlet port 18 without having to flow around the outer edge of top baffle 20, which may be used to reduce turbulence. Channels 72 may be curved to induce a rotational flow in the fluid flowing down along the outside of channels 72 and/or in the gas passing through channels 72.

Referring to FIG. 8-11, there may be variations in the baffles within vessel 12. For example, bottom baffle 30 may be flat (not shown), rather than angled as shown in FIG. 1 and spaced lower in vessel 12. Alternatively, bottom baffle 30 may be removed altogether and the height of baffles 40 adjusted accordingly to achieve the desired flow path, as shown in FIG. 8. Referring to FIG. 9, bottom baffle 30 may be perforated or, referring to FIG. 10, there may be an additional perforated baffle 30a above bottom baffle 30. The perforations allow sand to fall toward the bottom as it separates from the fluid flow, while still generally causing the fluid to flow through series of baffles 40 along the same path. Referring to FIG. 11, series of baffles 40 may be angled, which may be used to adjust the flow characteristics of the fluid. Alternatively, as shown in FIG. 1, the bottom edge of some baffles may be angled, either inward or outward.

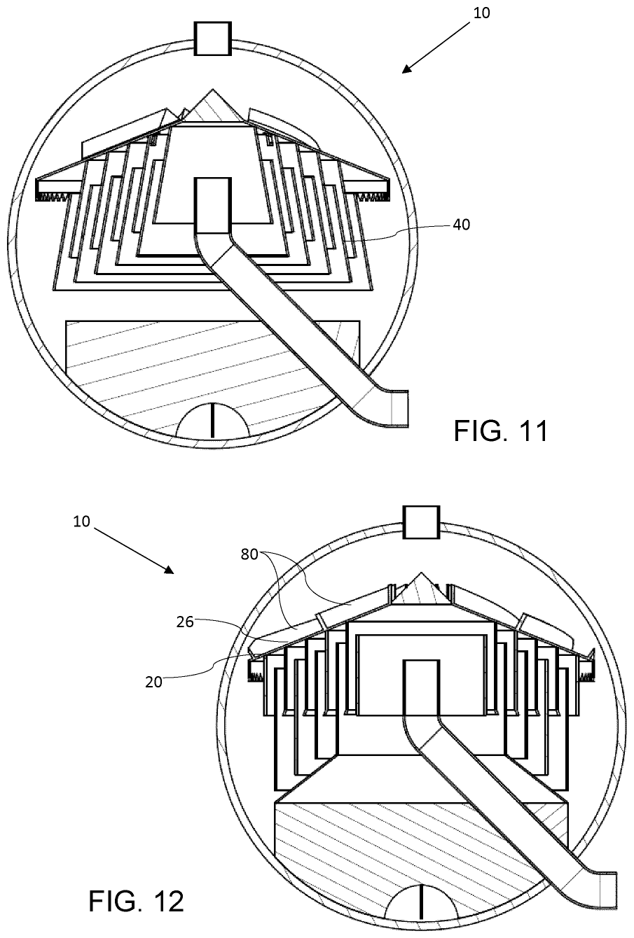

Referring to FIG. 12, there may be vanes 80 on top surface 26 of baffle 20 to induce a circular component into the fluid flow. This may be combined with an offset or angled inlet port 16 if desired (not shown).

Referring to FIG. 13, separator 10 may have a vertical vessel 82. As shown, vertical vessel 82 may be designed similar to spherical vessel 12 with series of baffles 40 and designed with a similar flow path to what is shown in FIG. 1. Vertical vessel 82 may be used to increase the amount of storage for sand at the bottom. Referring to FIG. 14, separator may have a horizontal vessel 84. In this case, separator 10 does not include a top baffle that separates inlet port 16 and outlet port 18. Inlet port 16 and outlet port 18 are spaced along a horizontal axis 86 and series of baffles 40 are positioned between inlet ports 16 and outlet ports 18, with first set of baffles 42 depending from the top of vessel 84 and second set of baffles 52 spaced below top of vessel 84. Vessel 84 has a sloped bottom 88 that allows sand to settle and collect toward the bottom of vessel 84 adjacent to outlet port 18. In this or other embodiments, it may be desired to have a phase separator that removes gas upstream of separator 10 to ensure that the fluid through separator 10 is primarily liquid and sand.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. A particulate separator comprising:
a vessel having a vertical axis, an inlet port toward a top of the vessel, and a fluid outlet port;
a top baffle extending radially from an outer edge toward the vertical axis, the top baffle being positioned between the inlet port and the fluid outlet port;
a radial flow channel below the top baffle from the outer edge toward the fluid outlet port; and
a series of baffles positioned concentrically about the fluid outlet port and within the radial flow channel, the series of baffles comprising:
a first set of baffles having a top edge connected to a bottom surface of the top baffle and a bottom edge spaced below the top edge; and
a second set of baffles having a top edge spaced from a bottom surface of the top baffle, the first set of baffles being interleaved with the second set of baffles to define an alternating flow path along the radial flow channel from the outer edge to the fluid outlet port.

2. The particulate separator of claim 1, further comprising a bottom baffle below the series of baffles, wherein the bottom baffle extends radially from an outer edge toward the vertical axis.

3. The particulate separator of claim 2, wherein one or both of the top baffle and the bottom baffle extends upward and toward the vertical axis from the outer edge.

4. The particulate separator of claim 2, wherein the bottom edges of the first set of baffles and the second set of baffles are each spaced above the bottom baffle.

5. The particulate separator of claim 4, wherein the bottom edges of the second set of baffles are positioned above the bottom baffle such that particulates separated from a fluid flow are permitted to flow toward the outer edge of the bottom baffle.

6. The particulate separator of claim 2, wherein the bottom baffle comprises an inner edge that defines a central opening, wherein the second set of baffles comprises an intermediate baffle having a bottom edge that is mounted to the bottom baffle at, or immediately adjacent to, the inner edge of the bottom baffle.

7. The particulate separator of claim 2, comprising one or more bottom baffles, a top one of the one or more bottom baffles being perforated to allow sand to pass through the perforated bottom baffle.

8. The particulate separator of claim 1, wherein the top baffle comprises gas vents toward a center of the top baffle.

9. The particulate separator of claim 8, wherein the gas vents comprise channels having an inlet at a first end of the channel above the top baffle, and an outlet through the top baffle that is spaced from the inlet along the channel.

10. The particulate separator of claim 1, wherein the fluid outlet port is positioned between the bottom edge and the top edge of an innermost baffle of the series of baffles.

11. The particulate separator of claim 1, wherein the inlet port and the fluid outlet port are axially aligned.

12. The particulate separator of claim 1, wherein the vessel is a spherical or cylindrical vessel.

13. The particulate separator of claim 1, wherein the bottom edge of the first set of baffles is angled away from the vertical axis.

14. A method of separating particulate from a fluid stream, comprising:
providing a particulate separator as claimed in claim 1;
passing a fluid flow through the particulate separator such that the fluid flow follows the alternating flow path through the series of baffles; and
permitting fluid to exit the vessel via fluid outlet port, and collecting sand in a bottom of the vessel.

15. A particulate separator comprising:
a vessel having an inlet, a fluid outlet port, and defining a flow channel between the inlet and the fluid outlet port; and
a series of baffles positioned within the flow channel between the inlet and the fluid outlet port, the series of baffles comprising:
a first set of baffles having a top edge connected to a top of the flow channel and a bottom edge spaced below the top edge; and
a second set of baffles having a top edge spaced below the top of the flow channel, the first set of baffles being interleaved with the second set of baffles to define an alternating flow path along the flow channel from the outer edge to the fluid outlet port.

16. The particulate separator of claim 15, wherein the vessel is a horizontal vessel, and the inlet and the fluid outlet port are spaced along a length of the horizontal vessel.

17. The particulate separator of claim 15, wherein the top of the flow channel comprises an inner surface of the vessel.
